(19) United States
(12) Patent Application Publication
(10) Pub. No.: US 2024/0117948 A1
(43) Pub. Date: Apr. 11, 2024

(54) MULTI-LENS ASSEMBLY OF LAMP

(71) Applicant: HYUNDAI MOBIS CO., LTD., Seoul (KR)

(72) Inventor: Young Geun JUN, Yongin-si (KR)

(73) Assignee: HYUNDAI MOBIS CO., LTD., Seoul (KR)

(21) Appl. No.: 18/474,169

(22) Filed: Sep. 25, 2023

(30) Foreign Application Priority Data
Oct. 4, 2022 (KR) 10-2022-0126083

(51) Int. Cl. F21S 41/255; F21S 41/153; F21S 41/20; G02B 3/04

(52) U.S. Cl. CPC F21S 41/255; F21S 41/153; F21S 41/285; G02B 3/04; F21Y 2115/10

(57) ABSTRACT

A multi-lens assembly for a lamp requiring a long focal length and higher optical performance, such as an adaptive driving beam (ADB) head lamp. The multi-lens assembly lamp may ensure higher optical performance with fewer lenses. More particularly, the multi-lens assembly may ensure a desired optical performance by including appropriately-arranged three lenses, i.e., two spherical lenses and one aspheric lens, and optimizing an optical design therebetween.

### CROSS-REFERENCE TO RELATED APPLICATIONS

This application claims priority under 35 U.S.C. §119 to Korean Patent Application No. 10-2022-0126083, filed on Oct. 04, 2022, in the Korean Intellectual Property Office, the disclosure of which is incorporated herein by reference in its entirety.

### TECHNICAL FIELD

The following disclosure relates to a multi-lens assembly of a lamp used for a lamp such as an adaptive driving beam (ADB) headlamp, which may illuminate a fairly long distance, and more particularly, to an optical structure having an arrangement of lenses and additional optical parts used for a lamp requiring a long focal length and higher optical performance, such as the ADB headlamp.

### BACKGROUND

In general, various illumination devices are installed on the front and rear of a vehicle to provide a driver with safety and driving convenience, and in recent years, a light emitting diode (LED) is widely used as a light source for a vehicle illumination device. It is important for the illumination device using the LED as its light source to use a lens having a larger half field of view and a lower manufacturing cost while more efficiently delivering light emitted from the light source.

The vehicle illumination devices may be classified based on their functions into a head lamp (or headlight), a fog lamp (or fog light), and the like for the purpose of an illumination function, and a turn indicator, a brake light, and the like for the purpose of a signaling function. Among these lamps, the head lamp serves a very important function in safe driving as a means of securing the driver's forward view in a dark environment such as at night. Here, it may cause the vehicle driver to have a narrower forward view in a situation where a beam irradiated from the head lamp is biased downward, and cause glare to a driver of an oncoming vehicle from the opposite side in a situation where the beam is biased upward. Therefore, it is necessary to appropriately adjust a beam direction based on the situation.

The adaptive driving beam (ADB) head lamp may be also referred to as an intelligent or adaptive head lamp. This ADB head lamp has a function of preventing the glare from occurring in the driver of the oncoming vehicle or a driver of a preceding vehicle by automatically adjusting the angle, brightness, width, length, or the like of the beam when detecting the oncoming vehicle or the preceding vehicle in a state where the beam of the head lamp is directed upward (i.e., in a high beam state).

The ADB head lamp is being developed in a variety of ways, from a low-priced product of 10 segments or less to a HD-class ultra-high resolution product with over 1 million pixels. The more number of segments of the ADB head lamp, the less coverage of an individual segment. Accordingly, the ADB head lamp may have more number of lenses and higher complexity to ensure that the small individual segment has a sharp contrast ratio and is preserved without shape distortion. However, the number of lenses is directly related to a higher price and a more complex process, which needs a solution.

Japanese Patent Laid-Open No. 2012-247687 (“photographic lens, optical apparatus with photographic lens, and method of manufacturing photographic lens”, published on Dec. 13, 2012, and hereinafter referred to as the “prior art”) relates to manufacture of an optical system with an optical image stabilization function, and discloses a technique of implementing high performance with fewer lenses. However, the prior art may be applied to an optical apparatus for photographing, specifically, an ultra-wide-angle optical system having a very short focal length. Accordingly, it is inappropriate to apply this technique to a field of the head lamp having a much longer focal length.

There has been a steady demand for a lens assembly which may be applied to a lamp requiring higher optical performance such as high resolution while having such a long focal length, and also manufactured at a lower cost to promote higher economic feasibility and productivity.

Related Art Document]

Patent Document]

(Patent Document 1) Japanese Patent Laid-Open No. 2012-247687 (“photographic lens, optical apparatus with photographic lens, and method of manufacturing photographic lens,” and published on Dec. 13, 2012)

### SUMMARY

An embodiment of the present disclosure is directed to providing a multi-lens assembly of a lamp which may ensure higher optical performance with fewer lenses. More particularly, an embodiment of the present disclosure is directed to providing a multi-lens assembly of a lamp which may ensure a desired optical performance by including appropriately-arranged three lenses, i.e., two spherical lenses and one aspheric lens, and optimizing an optical design therebetween.

In one general aspect, a multi-lens assembly of a lamp, in which the front refers to a side far from an image surface 500, and the rear refers to a side close to the image surface, includes: an outer spherical lens 110 disposed at the forefront; an aspherical lens 120 disposed behind the outer spherical lens 110, made of a plastic material, and having a numerical aperture (NA) of 0.7 or more; and an inner spherical lens 130 disposed behind the aspherical lens 120.

The outer spherical lens 110 may have an Abbe number greater than 60 and less than 75, and the inner spherical lens 110 may have a refractive index of 1.8 or more in a d-line, and an Abbe number greater than 30 and less than 40.

The aspherical lens 120 may have an Abbe number greater than 20 and less than 30.

A front surface of the outer spherical lens 110 may be convex, and the aspherical lens 120 and the inner spherical lens 130 may be formed in a meniscus shape.

The assembly may further include a flat plate 140 disposed in the front closest to the image surface 500, and coated using an infrared blocking coating. The multi-lens assembly 100 may satisfy an expression below:

$$1.5 \leq \frac{{f}_{1}}{f} \leq 2.5$$

(Here, f₁ indicates a focal length of the outer spherical lens, and f indicates a focal length of an entire optical system).

The multi-lens assembly 100 may satisfy an expression below:

$$1.4 \leq \frac{{D}_{1}}{{D}_{3}} \leq 2.1$$

(Here, D₁ indicates a diameter of the outer spherical lens, and D3 indicates a diameter of the inner spherical lens).

The multi-lens assembly 100 may satisfy an expression below:

$$0.1 \leq \frac{{T}_{23}}{{L}_{T}} \leq 0.2$$

(Here, T₂₃ indicates a distance between the aspherical lens and the inner spherical lens, and L_{T} indicates a distance between a foremost surface of an optical system and the image surface).

The multi-lens assembly 100 may satisfy an expression below:

$$2 \leq \frac{{d}_{3}}{BFL} \leq 4.5$$

(Here, d₃ indicates a thickness of the inner spherical lens, and BFL indicates a distance between a rearmost surface of an optical system and the image surface).

The multi-lens assembly 100 may satisfy an expression below:

$$1.8 \leq \frac{{r}_{1}}{( {n}_{1} - 1 ) f} \leq 2.2$$

(Here, r₁ indicates a radius of curvature of a foremost surface of an optical system, n₁ indicates a refractive index of the outer spherical lens, and f indicates a focal length of the entire optical system).

The multi-lens assembly 100 may satisfy an expression below:

$$1.2 \leq \frac{{r}_{1}}{{r}_{5}} \leq 2$$

(Here, r₁ indicates a radius of curvature of a front surface of the outer spherical lens, and r₅ indicates a radius of curvature of a front surface of the inner spherical lens).

The assembly may further include an illuminance control unit 150 disposed on the image surface 500, and having a form of a light emitting diode (LED) array in which a single LED or a plurality of LEDs are disposed to form a pre-designed illuminance distribution on an opposite side of the image surface 500.

### BRIEF DESCRIPTION OF THE DRAWINGS

FIG. 1 is an optical path diagram of a first embodiment of a multi-lens assembly of a lamp.

FIG. 2 is a spot diagram of a first embodiment of the multi-lens assembly of a lamp.

FIG. 3 is an optical path diagram of a second embodiment of a multi-lens assembly of a lamp.

FIG. 4 is a spot diagram of a second embodiment of the multi-lens assembly of a lamp.

FIG. 5 is an optical path diagram of a third embodiment of a multi-lens assembly of a lamp.

FIG. 6 is a spot diagram of a third embodiment of the multi-lens assembly of a lamp.

FIG. 7 is an optical path diagram of a fourth embodiment of a multi-lens assembly of a lamp.

FIG. 8 is a spot diagram of a fourth embodiment of the multi-lens assembly of a lamp.

FIG. 9 is an illumination optical path diagram of an embodiment.

FIG. 10 shows an embodiment of an illuminance control unit.

### DETAILED DESCRIPTION OF EMBODIMENTS

Hereinafter, a multi-lens assembly of a lamp according to the present disclosure having the above configuration is described in detail with reference to the accompanying drawings.

A multi-lens assembly 100 of the present disclosure requires optical performance of a half field of view of about 20 degrees and numerical aperture (NA) of 0.75 or more. A representative example of an optical system having the NA of 0.75 or more may be a microscope objective lens, a pickup optical system, or the like. However, this optical system may have a very narrow field of view, and the microscope objective lens may use too many lenses to have poor manufacturability, productivity, and economic feasibility. In particular, excessively high resolution performance is not required for an optical system generating a desired intensity distribution of light in any area by using a light source in which small light emitting diodes (LEDs) are regularly arranged like a checkerboard.

Considering this point, the present disclosure aims to achieve an illumination optical system with higher efficiency and a larger field of view that may transmit more light emitted from the LEDs by responding to a high NA while using a very few number of lenses. Here, the simplest optical system may use only one lens. However, in this case, chromatic aberration correction is impossible. The optical system may include two lenses with two different Abbe numbers. However, in this case, image surface curvature correction is impossible when the field of view is slightly increased. In addition, spherical aberration may be rapidly increased as the NA is increased, and the optical system may thus necessarily use an aspherical lens to correct this problem with the limited number of lenses.

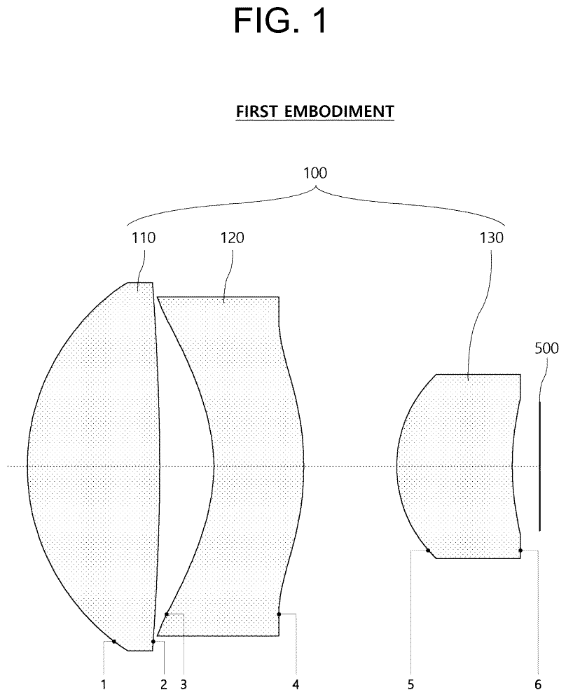

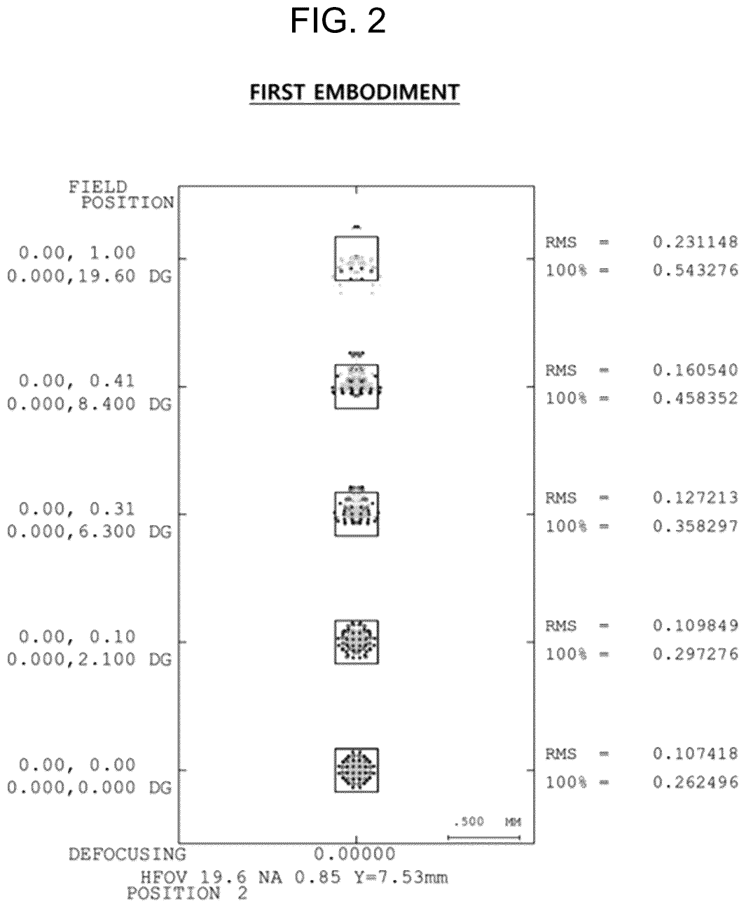

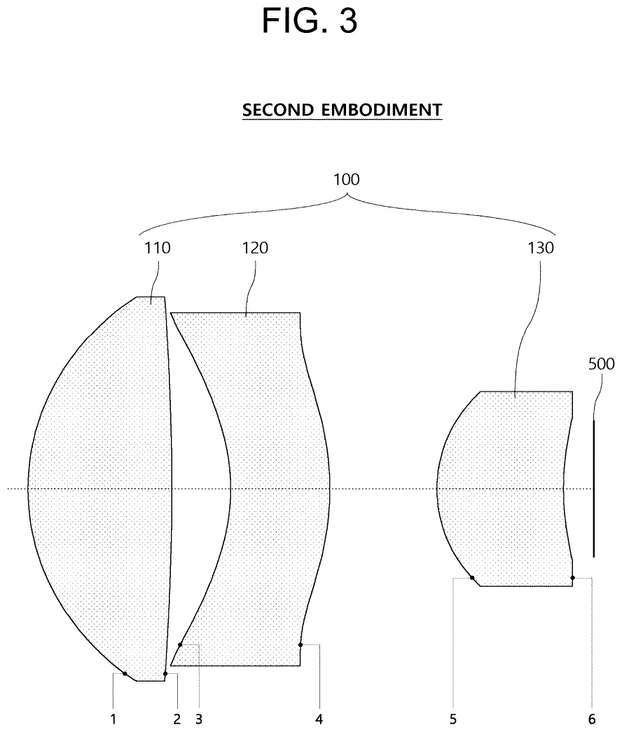

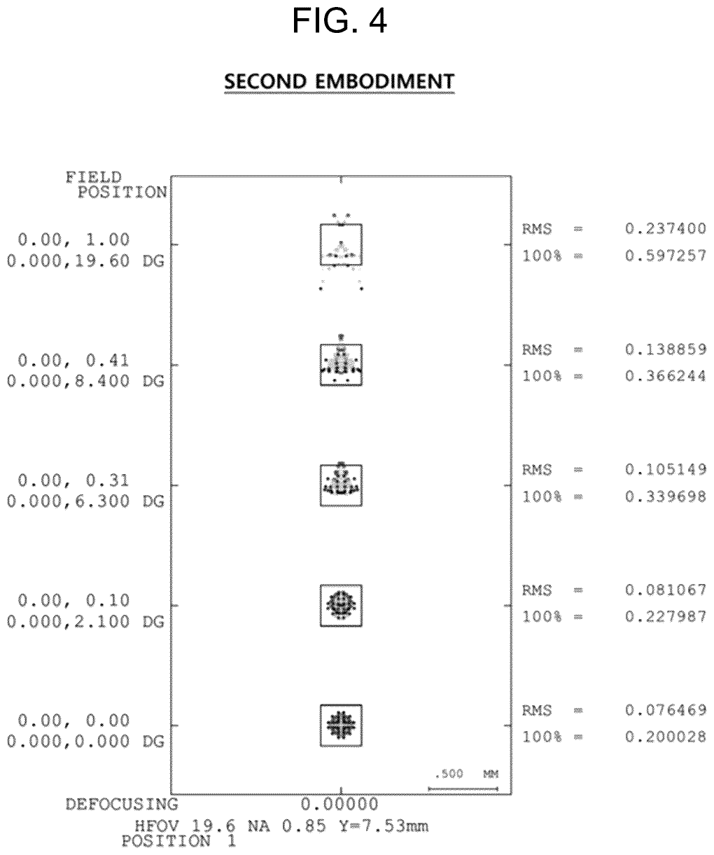

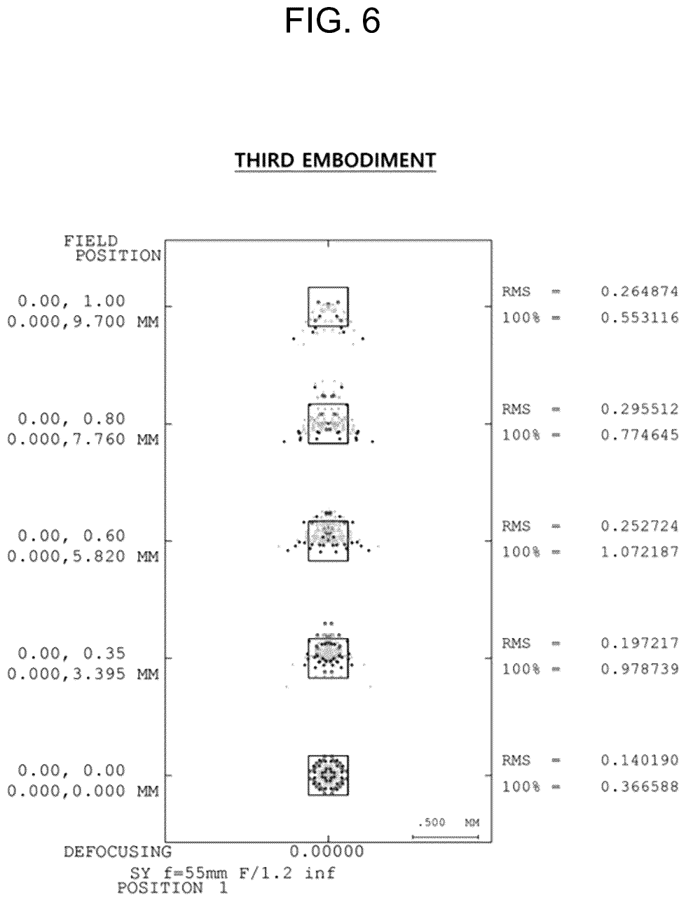

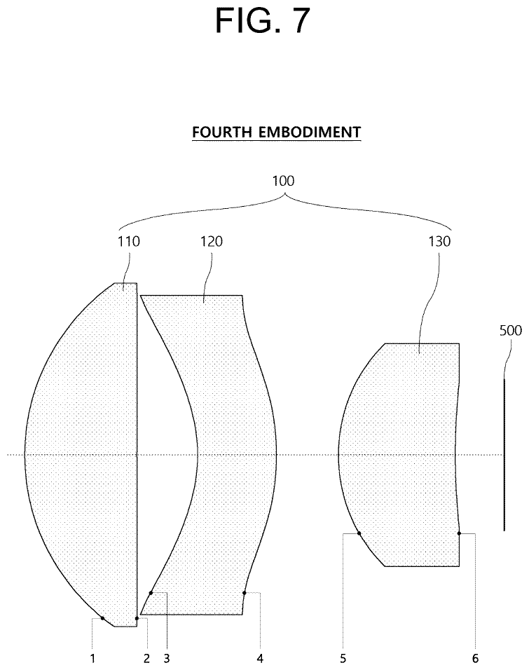

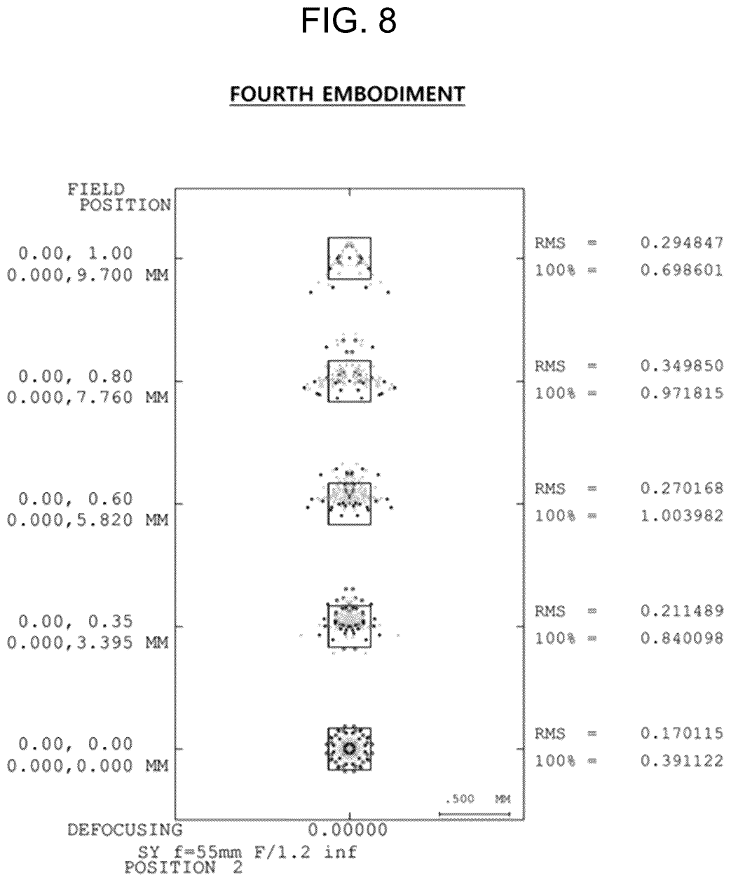

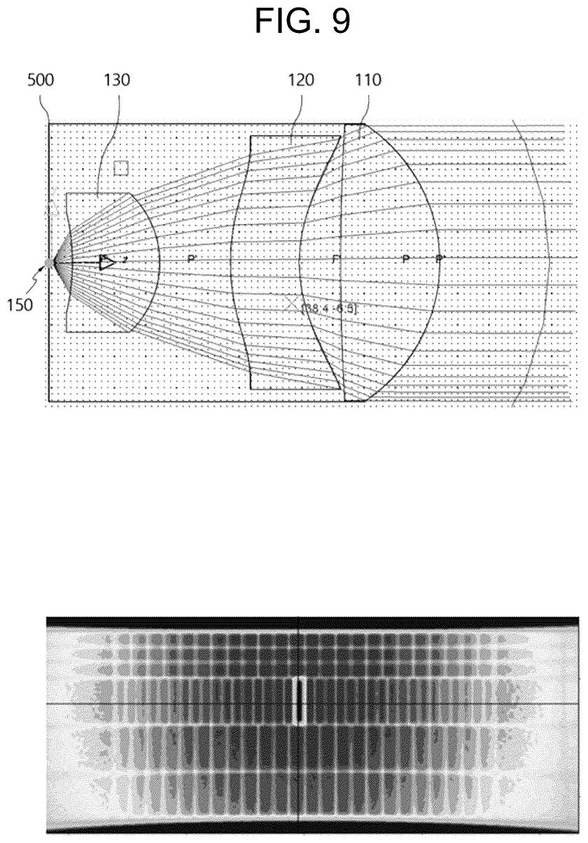

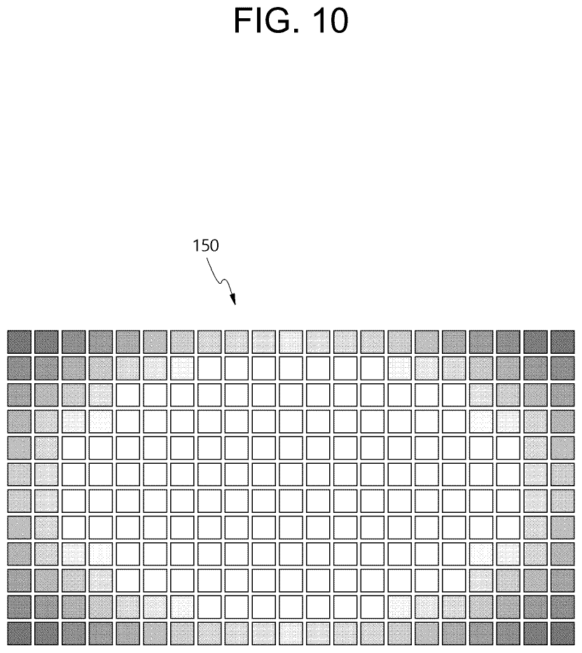

In order to solve this problem, the present disclosure may minimize the number of lenses by using three lenses, i.e., two spherical lenses with different Abbe numbers and one aspherical lens for aberration reduction. FIGS. 1, 3, 5, and 7 are respective optical path diagrams of first, second, third, and fourth embodiments of the multi-lens assembly of a lamp of the present disclosure. FIGS. 2, 4, 6 and 8 are respective spot diagrams of first, second, third and fourth embodiments. Referring to FIGS. 1 through 8, the multi-lens assembly 100 of the present disclosure may include an outer spherical lens 110, an aspherical lens 120, and an inner spherical lens 130, and may further include a flat plate 140. Meanwhile, FIG. 9 is an illumination optical path diagram of an embodiment, and FIG. 10 shows an embodiment of an illuminance control unit. Referring to FIGS. 9 and 10, the multi-lens assembly 100 of the present disclosure may further include an illuminance control unit 150. Hereinafter, each part is described in more detail.

Based on an image surface 500, i.e., surface where image points are collected, the front may refer to a side far from the image surface 500, and the rear may refer to a side close to an image surface 500. Here, in the multi-lens assembly 100 of the present disclosure, the outer spherical lens 110, the aspherical lens 120, and the inner spherical lens 130 may be sequentially arranged from the front to the rear. That is, the outer spherical lens 110 may be disposed at the forefront (i.e., farthest from the image surface 500), the aspherical lens 120 may be disposed behind the outer spherical lens 110 (i.e., between the outer spherical lens 110 and the inner spherical lens 130), and the inner spherical lens 130 may be disposed behind the aspherical lens 120 (i.e., closest to the image surface 500 among the three lenses).

Here, the aspherical lens 120 may be made of a plastic material. It is well known that when manufacturing a lens, a manufacturing cost of the lens may be generally increased because an aspheric lens has a complex shape, is difficult to be processed, or the like compared to a spherical lens. In this way, it is possible to lower the manufacturing cost by providing the aspherical lens 120 made of the plastic material. In addition, the aspherical lens 120 may be disposed between the outer spherical lens 110 and the inner spherical lens 130 as described above. Therefore, the aspherical lens 120 may be prevented from external impact due to the outer spherical lens 110, and protected from damage caused by heat occurring from illumination due to the inner spherical lens 130. Accordingly, the aspherical lens 120 may ensure its sufficient durability and lifespan even when made of the plastic material having lower environmental resistance and vulnerable to heat.

In addition, the aspherical lens 120 may have the NA of 0.7 or more. The spherical aberration may be rapidly increased as the NA is increased, and the multi-lens assembly 100 of the present disclosure may preferably use the aspherical lens. As described above, it is difficult to manufacture the aspherical lens compared to the spherical lens, thus increasing the manufacturing cost. It is possible to lower the manufacturing cost compared to a case of using a glass material by using the plastic material.

Meanwhile, considering the fact that the outer spherical lens 110 is exposed to the external environment, the outer spherical lens 110 may preferably be made of the glass material having higher environmental resistance. In particular, the outer spherical lens 110 may preferably use a crown glass material having a low dispersion rate. In addition, considering that the inner spherical lens 130 is most exposed to heat occurring from illumination, the inner spherical lens 130 may also preferably use a glass material having higher heat resistance. When the outer spherical lens 110 is determined to be made of the crown glass material, the inner spherical lens 110 may preferably be determined to be made of a flint glass material having a lower Abbe number.

As described above, the outer spherical lens 110 and the inner spherical lens 130 may have two different Abbe numbers for the chromatic aberration correction. Here, it may be advantageous for the outer spherical lens 110 to have a higher Abbe number. However, when having the Abbe number of 75 or more, the outer spherical lens 110 may have lower heat resistance and a poor lens processing characteristic while having higher chromatic aberration performance. In addition, considering the chromatic aberration correction, the outer spherical lens 110 may preferably have the Abbe number generally greater than that of the inner spherical lens 130. In more detail, the outer spherical lens 110 may have the Abbe number greater than 60 and less than 75, and the inner spherical lens 110 may have a refractive index of 1.8 or more in a d-line, and the Abbe number greater than 30 and less than 40.

In addition, as described above, the multi-lens assembly 100 of the present disclosure requires the aspherical lens 120 to correct image surface curvature and residual aberration when the field of view becomes larger. Here, the aspherical lens 120 may preferably have a smaller Abbe number than the outer spherical lens 110 and the inner spherical lens 130 in consideration of the chromatic aberration performance. In more detail, the aspherical lens 120 may have the Abbe number greater than 20 and less than 30.

Meanwhile, the multi-lens assembly 100 of the present disclosure may correspond to a telephoto-type optical system in which refractive power of the foremost lens is classified to be positive. Therefore, the lens farthest from the image surface 500, i.e., front surface of the outer spherical lens 110, needs to be convex. In addition, it is advantageous to correct the image surface curvature when the second and third lenses, that is, the aspherical lens 120 and the inner spherical lens 130, are formed in a meniscus shape.

As such, the multi-lens assembly 100 of the present disclosure may include three lenses of the outer spherical lens 110, the aspherical lens 120, and the inner spherical lens 130. When using more lenses, the present disclosure may require a higher cost while having higher resolution performance. Therefore, the present disclosure limits the number of lenses to three to minimize the number of lenses while achieving the required performance. In addition, as described above, the present disclosure may ensure the sufficient durability and lifespan due to the higher environmental resistance and heat resistance achieved through the configuration of the optical system in which the outer spherical lens 110 and the inner spherical lens 130 are made of glass, and the aspherical lens 120 is made of the plastic material to have the NA of 0.7 or more, and disposed between the outer spherical lens 110 and the inner spherical lens 130. The present disclosure may simultaneously ensure a desired optical performance, i.e., half field of view of about 20 degrees and the NA of 0.75 or more, while minimizing the aberration by using the aspherical lens.

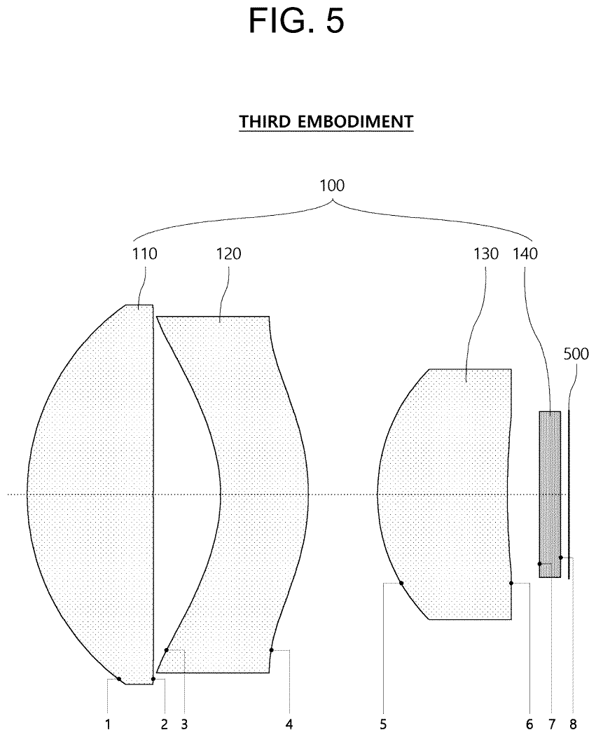

The multi-lens assembly 100 of the present disclosure may further include the flat plate 140 disposed in the front closest to the image surface 500, and coated with an infrared ray, as shown in an optical path diagram of a third embodiment of FIG. 5. The flat plate 140 is a component to prevent the lenses from being damaged by heat occurring from illumination installed on the image surface 500, and may be coated using the infrared blocking coating for effective heat dissipation. Here, the flat plate 140, as the name suggests, is not treated as a lens because this flat surface has no refractive power.

Hereinafter, various optical conditions related to the component arrangement in the multi-lens assembly 100 are described in detail.

First, in order for the multi-lens assembly 100 to be the telephoto type which is a basic type of the optical system, the lens disposed at the forefront, that is, the outer spherical lens 110, is required to have strong refractive power. This condition may be satisfied by appropriately determining an f₁/f value. However, a refraction angle may become small when the f₁/f value is excessively small, and conversely, a performance change occurring due to a lens assembly error may be increased when the f₁/f value is excessively large. Considering this point, the multi-lens assembly 100 may satisfy Expression 1 below.

$$1.5 \leq \frac{{f}_{1}}{f} \leq 2.5 \qquad [ Expression 1 ]$$

(Here, f₁ indicates a focal length of the outer spherical lens, and f indicates a focal length of the entire optical system).

In addition, in order for the multi-lens assembly 100 to be the telephoto type, the lens disposed at the forefront, that is, the outer spherical lens 110, is required to be larger than the lens that is disposed at the rearmost, that is, the inner spherical lens 130. This condition may be implemented by appropriately determining a value of D₁/D₃. However, the refractive power may become small not to show a telephoto characteristic when the value of D1/D3 is excessively small, and conversely, the performance change occurring due to the lens assembly error may be increased as in the above case when the value of D₁/D₃ is excessively large. Considering this point, the multi-lens assembly 100 may satisfy Expression 2 below.

$$1.4 \leq \frac{{D}_{1}}{{D}_{3}} \leq 2.1 \qquad [ Expression 2 ]$$

(Here, D₁ indicates a diameter of the outer spherical lens, and D₃ indicates a diameter of the inner spherical lens).

The multi-lens assembly 100 of the present disclosure may also consider the performance change occurring due to a position of the lens disposed at the rearmost, that is, the inner spherical lens 130. It is basically important that the inner spherical lens 130 has the meniscus shape to correct the image surface curvature. However, in the optical system having a very large NA as in the present disclosure, the smaller distance between the image surface 500 and the lens disposed at the rearmost, that is, the inner spherical lens 130, the better the performance. Accordingly, it is advantageous that a distance between the second lens, that is, the aspherical lens 120 and the last or third lens, that is, the inner spherical lens 130, are relatively large, in other words, the two lenses are relatively far from each other. However, the length of the optical system may be excessively long when this distance is excessively large, and conversely, the lens and the image surface may be excessively close to each other, and accordingly, the image surface may not be adjusted due to lens manufacturing tolerance, and heat from the LED may be directly transmitted to the lens. Considering this point, the multi-lens assembly 100 may satisfy Expression 3 below.

$$0.1 \leq \frac{{T}_{23}}{{L}_{T}} \leq 0.2 \qquad [ Expression 3 ]$$

(Here, T₂₃ indicates a distance between the aspherical lens and the inner spherical lens, and L_{T} indicates a distance between the foremost surface of the optical system and the image surface).

The multi-lens assembly 100 of the present disclosure may also consider the performance change occurring due to the position of the lens disposed at the rearmost, that is, the inner spherical lens 130. The lens may have an excessively smaller thickness when the front surface of the inner spherical lens 130 is excessively close to the image surface 500, resulting in the performance change occurring due to the assembly error caused by the strong refractive power, and in the opposite case, the lens may have an excessively greater thickness, resulting in lower lens processing characteristic, and a heavier optical system. Considering this point, the multi-lens assembly 100 may satisfy Expression 4 below.

$$2 \leq \frac{{d}_{3}}{BFL} \leq 4.5 \qquad [ Expression 4 ]$$

(Here, d₃ indicates a thickness of the inner spherical lens, and BFL indicates a distance between the rearmost surface of the optical system and the image surface).

The multi-lens assembly 100 of the present disclosure may also consider a condition to more reliably satisfy the telephoto condition. Expression 1 above only considers the focal length of the lens disposed at the forefront that is, the outer spherical lens 110. However, the multi-lens assembly 100 of the present disclosure may further consider a radius of curvature, a refractive index, or the like. Considering this point, the multi-lens assembly 100 may satisfy Expression 5 below.

$$1.8 \leq \frac{{r}_{1}}{( {n}_{1} - 1 ) f} \leq 2.2 \qquad [ Expression 5 ]$$

(Here, r₁ indicates a radius of curvature of the foremost surface of the optical system, n₁ indicates a refractive index of the outer spherical lens, and f indicates the focal length of the entire optical system).

It is also possible to minimize the aberration of the optical system by adjusting the arrangement of the lens that is disposed at the forefront, that is, the outer spherical lens 110 and the lens that is disposed at the rearmost, that is, the inner spherical lens 130. The description describes the reason why the diameter of the outer spherical lens 110 needs to be greater than that of the inner spherical lens 130 in relation to Equation 2 above. The curvature tends to be increased as the aperture of the lens is increased. It is thus necessary to appropriately determine a value of r₁/r₅ in relation to the curvature of each lens. The performance change occurring due to the assembly error of the outer spherical lens 110 may occur when the value of r₁/r₅ is excessively small, and conversely, not much refractive power may be applied to the outer spherical lens 110 when the value of r₁/r₅ is excessively large. Considering this point, the multi-lens assembly 100 may satisfy Expression 6 below.

$$1.2 \leq \frac{{r}_{1}}{{r}_{5}} \leq 2 \qquad [ Expression 6 ]$$

(Here, r₁ indicates a radius of curvature of the front surface of the outer spherical lens, and r₅ indicates a radius of curvature of the front surface of the inner spherical lens).

Meanwhile, the multi-lens assembly 100 of the present disclosure may allow an object image to be formed on the image surface 500. On the other hand, the multi-lens assembly 100 of the present disclosure may also ensure that only a desired area is illuminated by disposing a variously adjustable illumination, that is, the illuminance control unit 150, on the image surface 500. FIG. 9 exemplarily shows a case where the multi-lens assembly 100 includes the illuminance control unit 150 and a form of illumination produced based thereon.

As described above, the illuminance control unit 150 is the illumination disposed on the image surface 500, and in more detail, the illuminance control unit 150 may have the form of an LED array in which a single LED or a plurality of LEDs are disposed. Accordingly, the multi-lens assembly 100 of the present disclosure may have a pre-designed illuminance distribution formed on an opposite side of the image surface 500 by appropriately adjusting the illuminance control unit 150. FIG. 10 exemplarily shows that the multi-lens assembly 100 of the present disclosure has the pre-designed illuminance distribution formed using the illuminance control unit 150.

As set forth above, the multi-lens assembly of a lamp according to the present disclosure may ensure the higher optical performance of the half field of view of about 20 degrees and NA of 0.75 or more with only three lenses, i.e., two spherical lenses and one aspherical lens. In particular, the multi-lens assembly of a lamp according to the present disclosure may achieve the desired level of optical performance with the minimum number of lenses, and simultaneously obtain not only the improved durability and lifespan, but also the economic effect such as the lower cost by introducing the optimal arrangement in which the aspheric lens having the higher manufacturing cost and vulnerable to heat is disposed between the spherical lenses relatively manufactured easily and inexpensive.

The present disclosure is not limited to the above-described embodiments, and may be variously applied. In addition, the present disclosure may be variously modified by those skilled in the art to which the present disclosure pertains without departing from the gist of the present disclosure claimed in the claims.

What is claimed is:

1. A multi-lens assembly for a lamp, in which a front refers to a side far from an image surface, and a rear refers to a side close to the image surface, the assembly comprising:
an outer spherical lens disposed at the front;
an aspherical lens disposed behind the outer spherical lens, made of a plastic material, and having a numerical aperture of 0.7 or more; and
an inner spherical lens disposed behind the aspherical lens.

2. The assembly of claim 1, wherein the outer spherical lens has an Abbe number greater than 60 and less than 75, and the inner spherical lens 130 has a refractive index of 1.8 or more in a d-line, and an Abbe number greater than 30 and less than 40.

3. The assembly of claim 2, wherein the aspherical lens has an Abbe number greater than 20 and less than 30.

4. The assembly of claim 1, wherein a front surface of the outer spherical lens is convex, and
the aspherical lens and the inner spherical lens are formed in a meniscus shape.

5. The assembly of claim 1, further comprising a flat plate disposed in the front closest to the image surface, and coated using an infrared blocking coating.

6. The assembly of claim 1, wherein the multi-lens assembly satisfies an expression below:
$$1.5 \leq \frac{{f}_{1}}{f} \leq 2.5 ,$$
where f₁ indicates a focal length of the outer spherical lens, and f indicates a focal length of an entire optical system.

7. The assembly of claim 1, wherein the multi-lens assembly satisfies an expression below:
$$1.4 \leq \frac{{D}_{1}}{{D}_{3}} \leq 2.1 ,$$
where D₁ indicates a diameter of the outer spherical lens, and D3 indicates a diameter of the inner spherical lens.

8. The assembly of claim 1, wherein the multi-lens assembly satisfies an expression below:
$$0.1 \leq \frac{{T}_{23}}{{L}_{T}} \leq 0.2 ,$$
where T₂₃ indicates a distance between the aspherical lens and the inner spherical lens, and L_{T} indicates a distance between a foremost surface of an optical system and the image surface.

9. The assembly of claim 1, wherein the multi-lens assembly satisfies an expression below:
$$2 \leq \frac{{d}_{3}}{BFL} \leq 4.5 ,$$
where d₃ indicates a thickness of the inner spherical lens, and BFL indicates a distance between a rearmost surface of an optical system and the image surface.

10. The assembly of claim 1, wherein the multi-lens assembly satisfies an expression below:
$$1.8 \leq \frac{{r}_{1}}{( {n}_{1} - 1 ) f} \leq 2.2 ,$$
where r₁ indicates a radius of curvature of a foremost surface of an optical system, n₁ indicates a refractive index of the outer spherical lens, and f indicates a focal length of an entire optical system.

11. The assembly of claim 1, wherein the multi-lens assembly satisfies an expression below:
$$1.2 \leq \frac{{r}_{1}}{{r}_{5}} \leq 2 ,$$
where r₁ indicates a radius of curvature of a front surface of the outer spherical lens, and r₅ indicates a radius of curvature of a front surface of the inner spherical lens.

12. The assembly of claim 1, further comprising an illuminance control unit disposed on the image surface, and having a light emitting diode (LED) array in which a single LED or a plurality of LEDs are disposed to form a pre-designed illuminance distribution on an opposite side of the image surface.
